(19) United States
(12) Patent Application Publication
(10) Pub. No.: US 2015/0363828 A1
(43) Pub. Date: Dec. 17, 2015

(54) TRAFFIC ADAPTIVE DIGITAL BILLBOARD CONTROL SYSTEM

(71) Applicant: RSM Technologies Inc., San Francisco, CA (US)

(72) Inventor: Martin Mantalovos, San Francisco (CA)

(73) Assignee: RSM Technologies Inc., San Francisco, CA (US)

(21) Appl. No.: 14/738,063

(22) Filed: Jun. 12, 2015

Related U.S. Application Data
(60) Provisional application No. 62/012,755, filed on Jun. 16, 2014.

(51) Int. Cl. G06Q 30/02; G08G 1/01

(52) U.S. Cl. CPC G06Q 30/0261; G08G 1/0141

(57) ABSTRACT

A digital billboard control system and a method of controlling a digital billboard with real-time displays are each provided with a traffic monitoring module for monitoring traffic within a predetermined area adjacent each digital billboard in real-time, a network interface for communicating with a remote terminal, and a data processing controller operably interfaced with the real-time display, the traffic monitoring module and the networking interface. The controller receives real-time traffic data from the traffic monitoring module, and determines at least one traffic pattern adjacent the or each digital billboard from the received data. The controller outputs media content data to the real-time display according to a comparison between the determined traffic pattern and at least one predetermined context criteria, and communicates the determined traffic pattern and data representative of the media content data to the remote terminal in real-time for feedback about media data consumption by adjacent traffic.

This application claims the benefit of U.S. Provisional Patent Application 62/012,755 filed on 16 Jun. 2014, the specification of which is hereby incorporated herein by reference.

### BACKGROUND OF THE INVENTION

1. Field of the Invention

The present invention relates to digital billboard control systems. More particularly, the present invention relates to a digital billboard control system adapted to output billboard media content according to adjacent traffic patterns.

2. Description of the Related Art

Within the advertising industry, the billboard sector is non-trivial and, in the United States for instance, in 2012 the company CBS generated 9% of the parent company's revenue from the outdoor advertising segment, with a value of $1.3 billion. Another company, Clear Channel, generated revenues of $952 million that year through its outdoor advertising arm in the United States, and an additional $1.1 billion internationally.

Billboards, like any other form of advertising medium, rely on exposure rate data collated by organisations like the Traffic Audit Bureau, wherein the more accurate the numbers, the more value that can be placed on the content. The billboard sector has thus been gradually losing ground in value to the online advertisement sector, which provides advertisers with significantly more precise exposure data, analogous to advertisement consumption by targeted audiences, relative to static displays in public areas.

There is an estimated total of 400,000 billboards currently in use in the United States, of which only approximately 4,000 are of the digital type, and which are increasingly replacing the traditional static or mechanical type. Digital billboards have mitigated in part the aforementioned decline, because their video display permits the cycling display of more content per billboard location, whereby granularity added to the advertisement has justified a premium with advertisers.

Nevertheless, the ubiquity of online advertisement has, in the same time, been dramatically increased by the widespread adoption of mobile internet-enabled mobile telephone handsets and other portable wide area network-connected devices, such that the gradual replacement of traditional billboards with digital display-based billboards may eventually become uneconomical.

Moreover, known digital billboards still only perform a straightforward display function, substituting print technology for a real-time display technology, with cycling manually-selected and -stored video content according to manually-input predetermined intervals, without active real-time input from their changing surroundings and context.

An object of the present invention is to provide digital billboards with real-time adaptability to dynamic traffic changes in their vicinity, so as to improve the accuracy and granularity of their exposure rate data.

### BRIEF SUMMARY OF THE INVENTION

Fully-automated and adaptive traffic management systems are increasingly being deployed, which control the operation of vehicle-signalling devices such as traffic lights and variable speed limit panels, in response to dynamic traffic conditions. An example of such adaptive urban traffic control systems (UTCS) is the Fuzzy Logic Integrated Traffic System (FITS′) of the present assignee, disclosed in WO2011/033042 and incorporated herein by reference.

In the FITS system, a legacy signal controller is slaved to a terminal, which detects and collects traffic data from the road network in real-time with one or more local detectors, such as a transponder, radar or the like, and models the collected traffic data correspondingly in real-time, to which a number of metrics including, speed, volume and waiting time can be mapped, wherein the mapped model can be output to a user in a user interface.

A proven benefit of the FITS system is speed and accuracy, as the system collects and compiles data at between 50 and 70 times per second, with a data accuracy calculated at approximately 95% and wherein the data exhibits very high levels of granularity. This may be contrasted with traffic data aggregation achieved through crowd-based data sourcing models reliant upon individual mobile telephony devices, for instance as provided by the subsidiary Waze Mobile of Google Inc., the traffic data of which is up to 2 minutes old with a data accuracy calculated at approximately 5% at any given time.

The inventors have realised that equipping digital billboards with the real-time traffic detecting and modelling capacity of the FITS system yields a smart digital billboard capable of both reporting accurate exposure data based upon the detected traffic and adapting its displayed content to nearby traffic patterns.

Thus, according to an aspect of the present invention, a digital billboard control system is provided, which comprises at least one digital billboard having a real-time display and a traffic monitoring module adapted to detect and monitor traffic within a predetermined area adjacent the or each digital billboard in real-time, and a data processing controller operably interfaced with the real-time display, the traffic monitoring module and a networking interface adapted to communicate bilaterally with a remote data processing terminal; wherein the data processing controller is adapted to receive real-time traffic data from the traffic monitoring module, determine at least one traffic pattern adjacent the or each digital billboard from the received data, output media content data to the real-time display according to a comparison between the determined traffic pattern and at least one predetermined context criteria, and communicate the determined traffic pattern and data representative of the media content data to the remote data processing terminal.

In an embodiment of the system, the data processing controller may be interfaced with a plurality of real-time displays and traffic monitoring modules of respective digital billboards.

An alternative embodiment of the system may comprise a plurality of data processing controllers, each interfaced with a real-time display and traffic monitoring module of a respective digital billboard.

In a variant of this embodiment, the data processing controllers may be in data communication with one another through respective network interfaces and each controller is further adapted to communicate the determined traffic pattern to a next data processing controller along a direction of traffic flow, such that a further predetermined context criteria comprises the communicated traffic pattern.

In an embodiment of the system, the data processing controller may be further adapted to store the media content data as a plurality of video files and to select which video file to output according to the comparison.

In an embodiment of the system, the data processing controller may be further adapted to select media content data stored remotely at a or the remote terminal according to the comparison, and to stream the selected media content data from the remote terminal for output to the real-time display.

In an embodiment of the system, the data processing controller may download the or each predetermined context criteria from the remote data processing terminal.

In an embodiment of the system, the data processing controller may be adapted to process and output the determined traffic pattern and data representative of the media content data communicated by the data processing controller to a user interface.

According to another aspect of the present invention, a digital billboard is provided, which comprises a real-time display, a traffic monitoring module adapted to detect and monitor traffic within a predetermined area adjacent the digital billboard in real-time, a network interface adapted to communicate bilaterally with a remote data processing terminal, and a data processing controller operably interfaced with the real-time display, the traffic monitoring module and the networking interface, wherein the controller is adapted to receive real-time traffic data from the traffic monitoring module, determine at least one traffic pattern adjacent the digital billboard from the received data, output media content data to the real-time display according to a comparison between the determined traffic pattern and at least one predetermined context criteria, and communicate the determined traffic pattern and data representative of the media content data to the remote data processing terminal.

In an embodiment of the digital billboard, the traffic monitoring module may comprise a radar module adapted to detect each vehicle passing through the predetermined area.

In an embodiment of the digital billboard, the data processing controller may be configurable and updateable by the remote terminal.

In an embodiment of the digital billboard, the data processing controller may be in data communication with respective data processing controllers of adjacent digital billboards and be further adapted to communicate the determined traffic pattern to a next data processing controller along a direction of traffic flow, such that a further predetermined context criteria comprises the communicated traffic pattern.

According to yet another aspect of the present invention, a method of controlling a digital billboard adjacent a roadway is provided, which comprises the steps of detecting and monitoring traffic in real-time within a predetermined area adjacent the billboard with a traffic monitoring module, communicating the real-time traffic data to a data processing controller and determining at least one traffic pattern adjacent the digital billboard from the received data, comparing the determined traffic pattern with at least one predetermined context criteria and outputting media content data to a real-time billboard display according to the comparison, and communicating the determined traffic pattern and data representative of the media content data to a remote data processing terminal with a network interface.

In an embodiment of the method, wherein respective data processing controllers of a plurality of billboards are in data communication with one another through respective network interfaces, the method may comprise the further step of communicating the determined traffic pattern to a next data processing controller along a direction of traffic flow, such that a further predetermined context criteria comprises the communicated traffic pattern.

An embodiment of the method may comprise the further steps of storing the media content data as a plurality of video files and wherein the step of outputting further comprises selecting which video file to output according to the comparison.

In an embodiment of the method, the step of outputting may further comprise selecting media content data stored at a or the remote terminal according to the comparison, and streaming the selected remote media content data to the real-time display.

According to a further aspect of the present invention, a computer program is provided, which comprises program instructions for causing a digital billboard controller operably interfaced with a traffic monitoring module to perform a digital billboard controlling method as described herein.

For any of the above embodiments, the at least one predetermined context criteria is preferably selected from the group comprising traffic volume, traffic speed, traffic distribution, vehicle size, chronological data, meteorological data, geographical location of the or each billboard, display content type, display content duration, road safety information.

It will be appreciated that the field of view can be created in front of the billboard. Moreover the billboard to driver element allows billboards to target individuals based on traditional re-branding tools such as double click and cookies and a mobile phone locator associated with the driver. The system and method of the invention allows the ability for drivers to download a coupon to their car interface so that they can redeem a discount later based on the advertisement.

Other aspects of the invention are as set out in the appended claims.

### BRIEF DESCRIPTION OF THE DRAWINGS

The invention will be more clearly understood from the following description of an embodiment thereof, given by way of example only, with reference to the accompanying drawings, in which:

FIG. 1 illustrates a digital billboard controlling system according to an embodiment of the invention, wherein a digital billboard is located adjacent a roadway and in network connection with a remote data processing terminal.

FIG. 2 shows a logic diagram of the digital billboard shown in FIG. 1, including a real-time display, a traffic monitoring module, a network interface and a data processing controller.

FIG. 3 shows a logic diagram of the remote data processing terminal of FIG. 1, including memory means.

FIG. 4 provides a functional representation of data communications between the digital billboard controller, traffic monitoring module, network interface and remote data processing terminal of FIGS. 1 to 3 for controlling the digital billboard in real-time.

FIG. 5 illustrates steps of a billboard-controlling data processing method implemented in the system of FIGS. 1 to 3 for performing the data communications shown in FIG. 4.

FIG. 6 shows an example of a user interface displayed by the remote data processing terminal and updated according to the method shown in FIG. 5.

FIG. 7 illustrates a digital billboard controlling system according to an alternative embodiment of the invention, wherein a plurality of digital billboards are located proximate one another adjacent a roadway and in network connection with a remote data processing terminal.

### DETAILED DESCRIPTION OF THE DRAWINGS

The words “comprises/comprising” and the words “having/including” when used herein with reference to the present invention are used to specify the presence of stated features, integers, steps or components but does not preclude the presence or addition of one or more other features, integers, steps, components or groups thereof.

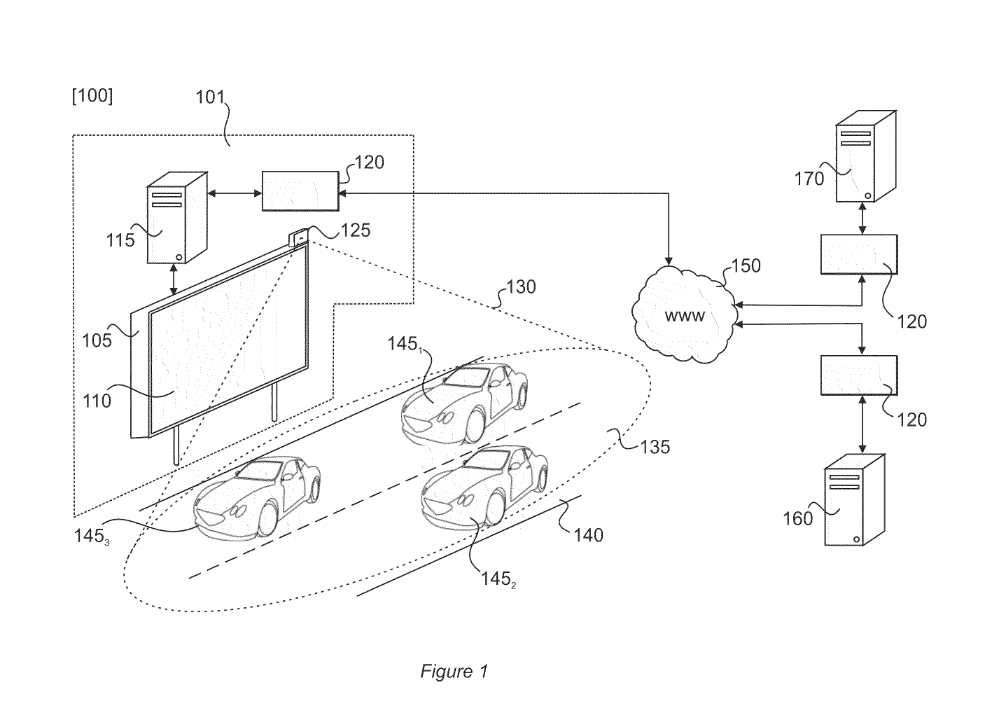

With reference to FIGS. 1 to 3 herein, a first embodiment of a digital billboard controlling system 100 according to the invention is shown, wherein a digital billboard 101 is located adjacent a roadway 140 and in network connection across a wide area network 150 such as the Internet with at least a first remote data processing terminal 160 to which billboard data is reported so that real-time billboard data may be consulted in a user interface and, in this embodiment, a second remote data processing terminal 170 providing media content data to the billboard upon request.

Each of the billboard 101 and the remote data processing terminals 160, 170 has wired and/or wireless telecommunication emitting and receiving functionality over a wired Local Area Network (‘LAN’) and/or a wireless local area network (‘WLAN’) conforming to the 802.11 standard (‘Wi-Fi’). In each of the WAN 150 and LAN or WLAN, telecommunication is performed as alphanumeric and/or audio and/or video data using the Internet Protocol (IP), Hypertext Transfer Protocol (‘HTTP’) or Secure Hypertext Transfer Protocol (‘HTTPS’), the signal being relayed respectively to or from each device 101, 160, 170 by a proximate or built-in wired or wireless modem or modem-router 120 locally interfacing the device to the WAN communication network 150.

The digital billboard 101 includes a number of distinct component arranged in a weatherproof housing 105, including firstly a real-time display 110, for instance a Liquid Crystal Display (‘LCD’) panel with an Ingress Protection Marking (IP) to level 44 for dust and water resistance.

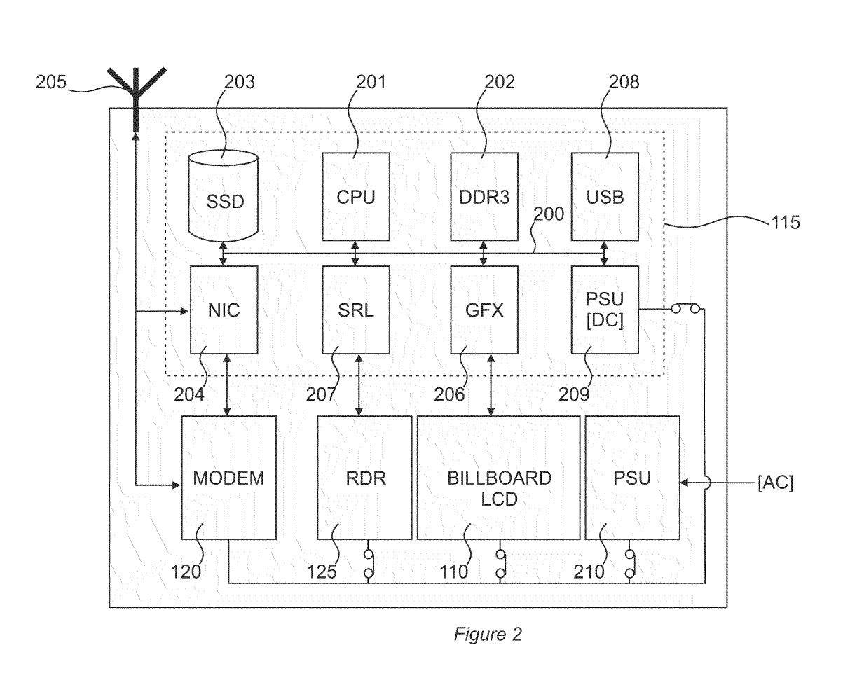

The digital billboard 101 next includes an industrial data processing terminal 115 configured as a data processing controller 115, which is shown distinctly in FIG. 1 for the purpose of clarity of disclosure but which, in practice, is embedded within the housing 105 as shown in FIG. 2. The industrial data processing controller 115 may for instance be an IGEPv5 processor board manufactured by ISEE 2007 S.L. of Barcelona, Spain.

All the data processing sub-components of the controller 115 are connected to one another via a data input/output bus 200, and a first sub-component is a dual-core ARM Cortex A15 central processing unit (CPU) 201 for task co-ordination and data processing functionality. Sets of instructions and data for the CPU 201 are stored in 4 gigabytes of double-data rate (DDR 3) synchronous dynamic random-access memory (RAM) 202 and a mSATA solid state drive (SSD) unit 203 facilitates non-volatile storage of the instructions and the data.

A wireless network interface card (NIC) 204 provides a bilateral data communication interface to a modem or modem-router 120 also housed within the weatherproof housing 105, which interfaces the digital billboard 101 with the wide area network 150. The NIC 204 suitably provides for both wired network connectivity conforming to the 10/100/1000 BaseT Ethernet format and wireless network connectivity conforming to the WIFI b/g/n and Bluetooth 4.0 LE standards, and thus includes an internal antenna and is interfaced with an external antenna 205, to which the modem 120 is also connected.

A video adapter 206 receives video data from the CPU 201 and outputs a video signal to the LCD panel 110 via a High Definition Multimedia Interface (HDMI) connector conforming to revision 1.4. The controller terminal 115 stores media content data in the SSD 203, in the example a plurality of advertisement clips encoded as digital video files, which the CPU 201 fetches, processes and outputs via the graphics interface 206 to the real-time display 110 as a video signal.

A serial RS232 DB9 interface 207 receives detected traffic data from a traffic monitoring module 125, which is shown distinctly in FIGS. 1, 3 and 8 for the purpose of clarity of disclosure but which, in practice, is embedded within the housing 105 as shown in FIG. 2 and provides the detected traffic data to the CPU 201 for processing according to the method described herein. In the example, the traffic monitoring module 125 is a radar module, for instance a K1-series radar detector manufactured by Tsien (UK) Limited trading under the name of Kestrel Radar Sensors. The radar module 125 of the billboard 101 is configured and oriented to detect vehicles 145_{N} passing within a field 135 of the adjacent roadway 140 that is defined by the radar aperture 130.

A further sub-component of the controller 115 is one or more universal serial bus (USB) input/output interface(s) 208, which facilitate ad hoc or permanent interfacing of the controller 115 with external peripherals and/or portable data storage, for instance for purposes of maintenance, or updating media content data or instructions in the SSD 203.

All the data processing sub-components 201 to 208 of the controller 115 are powered by a 5V DC input voltage power supply unit 209, which receives electrical power from a billboard power supply unit 210, which itself receives electrical power from a local mains power source and also supplies the billboard display, radar and modem components 110, 120, 125 according to component ratings and requirements.

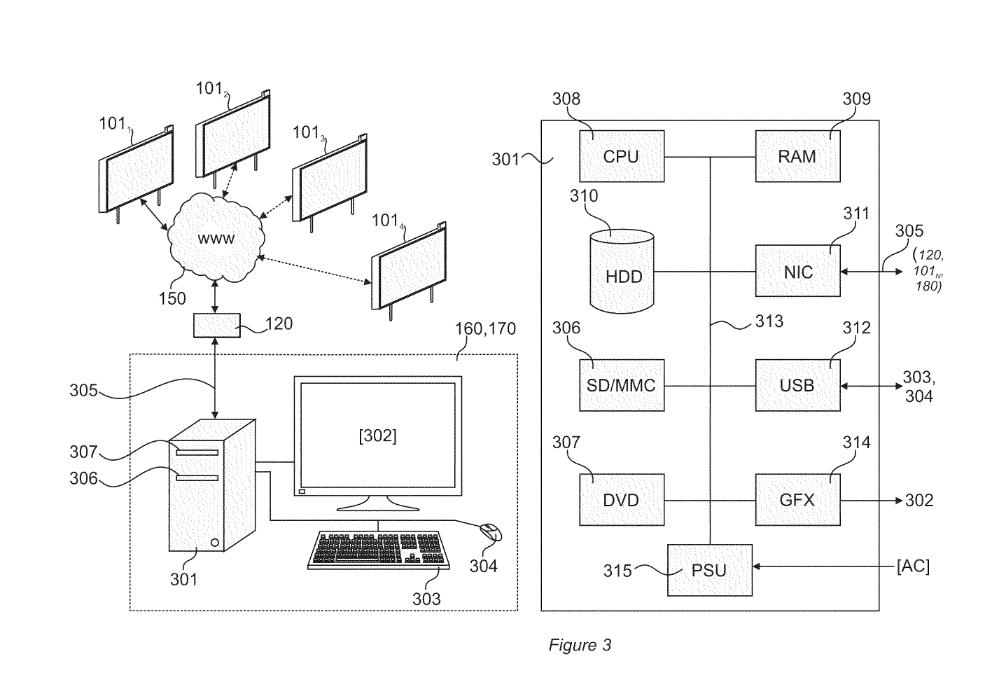

By contrast with the controller 115, the hardware architecture of data processing terminals 160, 170 is closer to that of a desktop, and a typical example is shown in FIG. 3 in further detail, by way of non-limitative example. Each data processing terminal 160, 170 is a computer configured with a data processing unit 301, data outputting means such as video display unit (VDU) 302, data inputting means such as HiD devices, commonly a keyboard 303 and a pointing device (mouse) 304, as well as the VDU 302 itself if it is a touch screen display, and data inputting/outputting means such as the wired network connection 305 to the communication network 150 via the router 120, a magnetic data-carrying medium reader/writer 306 and an optical data-carrying medium reader/writer 307.

Within data processing unit 301, a central processing unit (CPU) 308 provides task co-ordination and data processing functionality. Sets of instructions and data for the CPU 308 are stored in memory means 309 and a hard disk storage unit 310 facilitates non-volatile storage of the instructions and the data. A wireless network interface card (NIC) 311 provides the interface to the network connection 305. A universal serial bus (USB) input/output interface 312 facilitates connection to the keyboard and pointing devices 303, 304.

All of the above components are connected to a data input/output bus 313, to which the magnetic data-carrying medium reader/writer 306 and optical data-carrying medium reader/writer 307 are also connected. A video adapter 314 receives CPU instructions over the bus 313 for outputting processed data to VDU 302. All the components of data processing unit 301 are powered by a power supply unit 315, which receives electrical power from a local mains power source and transforms same according to component ratings and requirements.

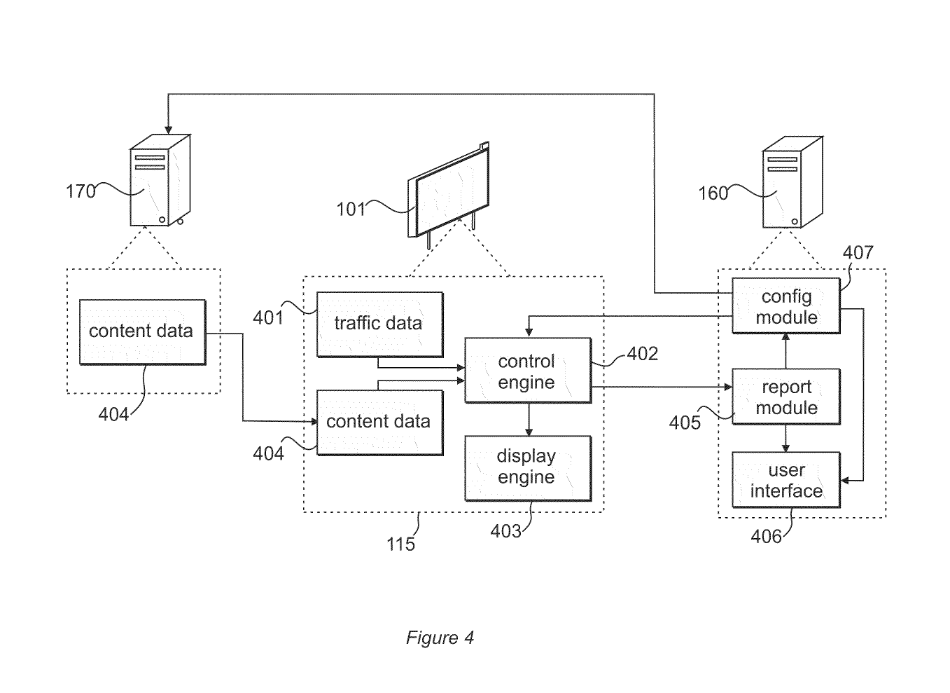

With reference to FIGS. 1 to 4 now, the inventive principle lies in a ‘smart’ digital billboard 101 with a field of vision 130, 135 which can accurately measure traffic flow and adapt advertising messages according to same in real-time, and report its operating parameters to a remote terminal 160 in real-time.

The controller 115 in the billboard 101 is thus configured with a set of instructions embodying different function-specific data processing modules, namely a traffic modelling engine 401, a billboard control engine 402 and a media content display or render engine 403.

The traffic modelling engine 401 provides real-time traffic monitoring functionality based on traffic data output by the radar module 125, so as to provide objectively-measured exposure data of the billboard media content to the passing public, with particularly high accuracy and granularity since the exact exposure time of each viewer can be determined. The traffic modelling engine 401 processes the passing traffic data into a digital traffic pattern or model in real-time, and submits the pattern data as an input to the billboard control engine 402.

The billboard control engine 402 selects or schedules media content 404 for retrieval from the SSD 203 and submission as an input to the display engine 403 for output to the LCD panel 110. The billboard media content 404 comprises for example video clips of product advertisements, movie trailers and newsreel announcements. The billboard control engine 402 selects or schedules this media content 404 according to one characteristic of the traffic pattern or more, for instance the average speed, volume or period of exposure of the passing traffic, by comparing such characteristic(s) to one or more predetermined threshold or criteria. Example criteria may include traffic volume level, average traffic speed, traffic distribution across multiple lanes, average vehicle size, chronological data such as time of day, meteorological data such as clear or overcast conditions, geographical location of the or each billboard, display content type, display content duration and road safety information.

The billboard control engine 402 further configures the controller 115 to communicate the traffic pattern in real-time to any querying remote terminal 160, together with data representative of the media content data displayed on the LCD panel 110, for instance the name or a video frame of the advertisement video clip file 404 currently being displayed, its duration and respective position in a default video file outputting cycle. The remote terminal 160 is correspondingly configured with a set of instructions embodying different function-specific data processing modules, namely a billboard reporting module 405, a user interface 406 and a billboard configuration module 407.

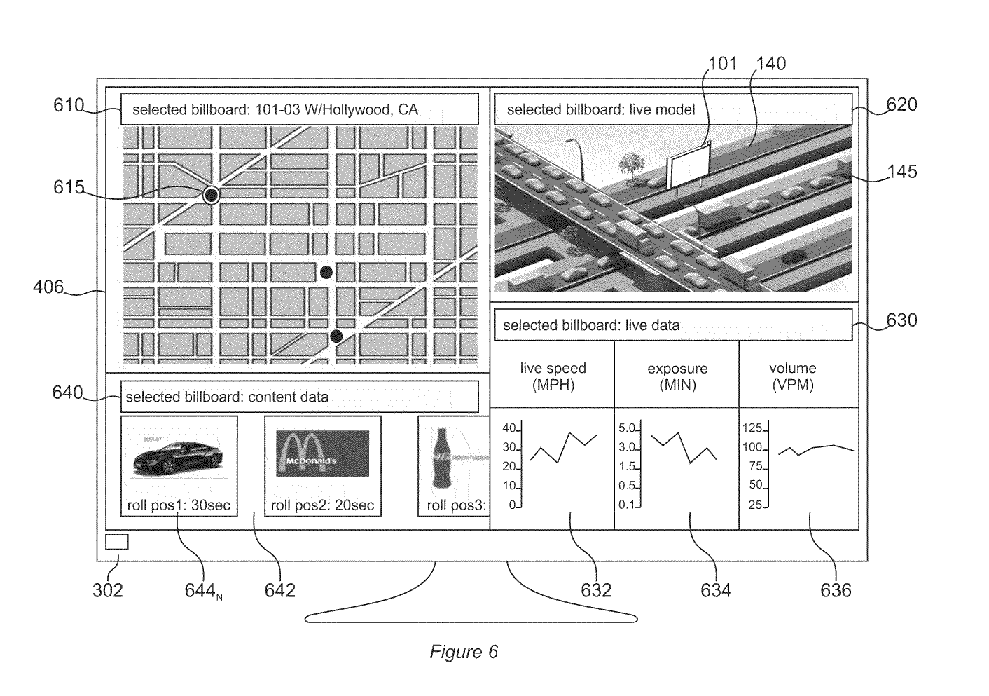

The billboard reporting module 405 receives the traffic pattern data communicated by the billboard control engine 402 for storage and any further analysis processes, and real-time reporting upon the operating conditions of a selected billboard 101 as described hereafter, in the interface 406, and embodiment of which is shown in, and described with reference to, FIG. 6 hereafter. The billboard configuration module 407 allows a user of the remote terminal 160 to configure and upload operating parameters for a selected billboard 101, such as additional, updated or replacement billboard media content 404, or network addresses pointing to same when the media content data is stored at a remote terminal 170, as well as additional, updated or replacement predetermined threshold or criteria.

The digital billboard 101 thus gives an accurate tally on the number of vehicles 145_{N} within the field 135, which in a preferred embodiment is up to 6 lanes across and 100 meters (300 feet) in length. The digital billboard 101 also gives an average length of exposure to the LCD display 110 by viewers aboard passing vehicles 145_{N}. The digital billboard 101 also gives an average speed for all vehicles 145_{N} within the field 135 to aid specifying an optimum run time for display content such as advertisements.

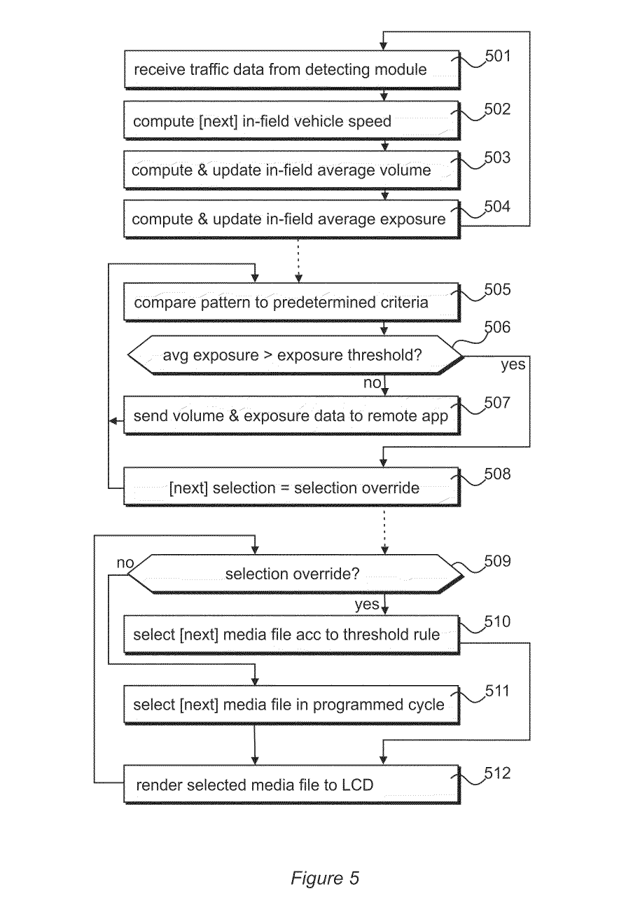

The data processing steps variously performed by the traffic module 401, control engine 402 and display engine 403 for controlling the operation of the billboard 101 at runtime and reporting data to the data processing terminal 101 in real-time shown in FIG. 5. The steps are described hereafter as discrete groups of chronological data processing tasks processed within a same processing cycle, and each such succession is repeated iteratively at runtime whilst the controller 115 of the billboard 101 is in use. It will be readily understood by the skilled person that such steps may be optimised and processed substantially in parallel, where the architecture of the CPU 208 and the basic instructions set and libraries for same allows.

The traffic detecting module 125 continuously acquires traffic data from any vehicles 145 passing on the roadway 140 within its effective field 135. At step 501, the acquired traffic data is compared by the traffic modelling engine 401 with the traffic data acquired in the previous processing cycle, and each radar return corresponding to a detected vehicle 145 is declared as either (N) newly-entered into the field 135 or (E) previously-entered into the field 135 and detected again. At step 502 the traffic modelling engine 401 computes the respective speed of each discrete radar return corresponding to a detected vehicle 145, relative to its previous position if validated as (E) and calculates an average speed for the detected vehicles 145. The traffic modelling engine 401 next computes the volume of detected vehicles 145 at step 503, from the number of discrete radar returns validated as (E) within the field 135. The traffic modelling engine 401 next computes the average exposure of detected vehicles 145 to the billboard 101 at step 504, by calculating a ratio of the average speed of step 502 to the length of the field 135, which is calibrated and known. Steps 501 to 504 correspond to a processing cycle of the traffic modelling engine 401 and control thus subsequently returns to step 501.

As control returns to step 501 for the traffic modelling engine 401, in a first sub-routine the billboard control engine 402 receives the average speed data of step 502, the average volume data of step 503 and the average exposure data of step 504 from the traffic modelling engine 401 and, at step 505, compares at least one received value against, respectively, either a predetermined traffic speed or a predetermined volume level or a predetermined exposure duration. A question is accordingly asked at step 506, as to whether the real-time data output by the traffic modelling engine 401 exceeds the predetermined threshold value. When the question of step 506 is answered negatively, the billboard is considered to operate optimally for the detected traffic conditions, and control accordingly proceeds to step 507, at which the billboard control engine 402 communicates the received average speed data of step 502, average volume data of step 503 and average exposure data of step 504 to the remote reporting module 405, and control returns to step 505 for considering the next output from the traffic modelling engine 401 afresh.

Alternatively, when the question of step 506 is answered positively, the billboard is considered to operate sub-optimally for the detected traffic conditions. For instance, when the traffic slows down significantly due to an emergency and then builds up, the calculated exposure soon exceeds a predetermined threshold based on the speed limit for the section of roadway 140 under observation. Accordingly, at an alternative step 508, the billboard control engine 402 registers a selection override for the media content 404, relative to a default cycle of media content associated with optimal traffic conditions. Control next proceeds to the communicating step 507, then step 505, as previously described.

A second sub-routine of the billboard control engine 402 controls the selection of media content for output to the LCD 110 via the display engine 403, selectively based upon the selection override of step 508. In the second sub-routine, a question is first asked at step 509, as to whether the selection override has been registered at step 508. When the question of step 509 is answered positively, the billboard control engine 402 selects a next media content 404 for processing by the display engine 403 at step 510, according to a rule triggered by the result of the comparison of step 506. In the example of the building tailback, the rule may specify that the billboard control engine 402 selects a next video clip with a longer runtime. Alternatively, still by way of non-limitative example, the rule may specify that the billboard control engine 402 instructs the display engine 403 to slow the playback frame rate so as to lengthen the duration of play of video clips. Alternatively, the question of step 509 is answered negatively, signifying that the media content is considered suitable for the detected traffic conditions, whereby the billboard control engine 402 selects a next media content 404 for processing by the display engine 403 at step 511 according to the default cycle of media content associated with optimal traffic conditions. The selection of either step 510 or step 511 is then passed to the display engine 403 at step 512, wherein the selected media file is retrieved from the SSD 203 or, depending on the embodiment, downloaded from the remote media server 170, and rendered to the LCD display 110.

An example of a user interface 406 displayed by the video display unit 302 of the remote data processing terminal 160 and updated according to step 508 is shown in FIG. 6. The user interface 406 comprises a variety of sections, some of which are dynamic and some others of which are interactive. The user interface 406 preferably reports at least the geographical location of a selected remote billboard 101, a historical view of traffic 145 adjacent the selected remote billboard 101, and a live record of media content 404 displayed. thereat Further embodiments may further include a predictive view of traffic 145 adjacent the remote billboard 101 extrapolated from historical data, a historical record f media content 404 displayed, including date, time and frequency of display.

Accordingly, in the embodiment shown in FIG. 6, a first interactive section 610 is a map section showing roadways 140 and other such representations of topological and infrastructural features, on which locations of one or more digital billboards 101_{N} are overlaid as user-selectable icons 615. Dynamic sections are updated in real-time by the control engine 402 of the remote billboard 101 selected by the operator of terminal 160 by way of its respective icon 615 on the map 610.

A first dynamic section 620 is a graphical animated window, in which the traffic pattern data reported by the controller 115 of the selected digital billboard 101 in real-time is rendered as a three-dimensional animation correspondingly in real-time, made up of three-dimensional models for each vehicle 145 detected by the radar module 125 of the selected digital billboard 101 shown in motion across a three-dimensional representation of the topology of the roadway 140 adjacent the selected digital billboard 101. This window provides the user of the terminal 106 with an intuitive display of the current level and flow rate of traffic adjacent the selected digital billboard 101. The three-dimensional scene 620 is rendered locally on the basis of the communicated traffic data, which is alphanumerical and thus very substantially smaller in bandwidth requirements than closed-circuit camera video frames, and accordingly less prone to network latency effects between the selected billboard 101 and the terminal 106.

A second dynamic section 630 is a second graphical animated window, in which the traffic pattern data reported by the controller 115 of the selected digital billboard 101 in real-time is rendered as several graphs plotting, respectively, the average speed (632) of the vehicles 145_{N} detected in the field 135 of the selected billboard 101, the average period of time of exposure (634) of the occupant(s) of the detected vehicles 145_{N} to the selected billboard 101, and the current traffic volume (634) adjacent the selected billboard 101, all updated in real-time whilst the same billboard remains selected. The second dynamic section 630 effectively provides another intuitive display of the current level and flow rate of traffic adjacent the selected digital billboard 101, with the first section 620 offering a qualitative representation and the second 630 offering a quantitative representation.

A third dynamic section 640 is a third window, in which the media content data 404 stored by the SSD 203 of the controller 115 of the selected billboard 101 is graphically displayed with respective composited media content icons 644_{N}, one for each video clip in the display cycle of the selected billboard 101, and each including a video frame representative of the advertisement, movie trailer or announcement, data indicative of the position of the clip in the display cycle relative to a first clip and data indicative of the length of the video clip.

In the window 640, the media content icons 644_{N} are shown one adjacent the other according to the play cycle, on a scrolling background 642 which is animated in real-time and synchronized with the remote display engine 403 of the selected billboard 101 so that, unless a user interacts with them, the icons 644_{N} scroll from right to left in synchronicity with the rendering of the corresponding video clips at the selected billboard 101 location. The window 640 is interactive, in that it allows a user of the terminal 160 to select a media content icon 644 through operation of the pointing device 304 and to perform a variety of operations thereon, for instance deleting, or displacing the selected icon 644 relative to the others along the scroll area 642 so that the corresponding video clip may be played at a different time in the cycle than previously.

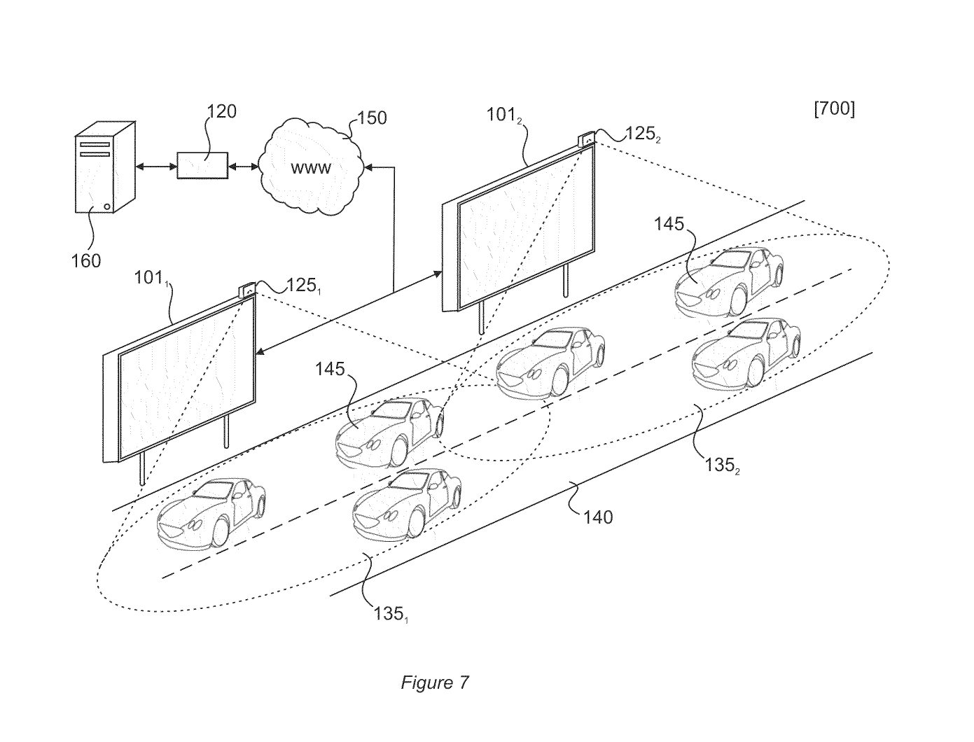

The user interface 406 accordingly provides an at-a-glance and highly intuitive real-time monitoring and configuring interface for one or more remote digital billboards 101_{N}. FIG. 7 illustrates a digital billboard controlling system 700 according to an alternative embodiment of the invention, wherein a plurality of digital billboards 101_{N} are located proximate one another adjacent the roadway 140 and in network connection with the remote data processing terminal 160. Each digital billboard 101_{N} is substantially identical to the digital billboard described with reference to FIGS. 1 to 5 and the remote data processing terminal 160 is similarly substantially identical to that described with reference to FIGS. 1 to 6.

In this embodiment, however, the average vehicle speed within adjacent fields 135₁, 135₂ is used by the respective control engines 402 of adjacent billboards 101₁, 101₂ as a priority predetermined context criteria to permit sequential advertising on successive billboards in the direction of travel of the nearest roadway 140 a row. The adjacent pairs of control engines 402 and display engine 403 of the adjacent billboards 101₁, 101₂ are in data communication via WLAN 120 and coordinated via to display the same media content 404 as a function of the distance travelled by a vehicle 145_{N} across both detection fields 135₁, 135₂, whereby a user observing the media content 404 on the first billboard 101₁ but leaving the first detection field 135₁ may continue to observe a continuation of the same media content 404 on the next billboard 101₂ when entering its respective and next detection field 135₂.

Further embodiments of the system according to the invention may correspondingly allow coordination of multiple billboards according to any further predetermined criteria, particularly thematic criteria such as regional grouping of billboards 101_{N} groups, demographic segmentation, and more.

The present invention thus allows billboard advertisers to create media content that is more targeted and time-sensitive, as exacting exposure data is reported to content providers, allowing them to observe current usage, but also to build historic and predictive usage data. In periods of long waiting times, for instance during tailbacks, media content can be longer and more diverse and more content can be added and cycled, generating more revenue for the billboard service providers. Alternatively, in periods of free-flowing traffic, the exact speed and viewing time may be used to cause the media content to be displayed faster, for instance at twice the frame rate. Further embodiments may also use predetermined criteria as a mood weighing factor, particularly chronological measurements derived from the computed average speed. Drivers immobilised in tailbacks for long periods of time are unlikely to respond well to media content depicting performance cars and open roads, but may on the contrary respond very well to holiday- or movie-themed media content.

The embodiments in the invention described with reference to the drawings comprise a computer apparatus and/or processes performed in a computer apparatus. However, the invention also extends to computer programs, particularly computer programs stored on or in a carrier adapted to bring the invention into practice. The program may be in the form of source code, object code, or a code intermediate source and object code, such as in partially compiled form or in any other form suitable for use in the implementation of the method according to the invention. The carrier may comprise a storage medium such as ROM, e.g. CD ROM, or magnetic recording medium, e.g. a floppy disk or hard disk. The carrier may be an electrical or optical signal which may be transmitted via an electrical or an optical cable or by radio or other means.

In the specification the terms “comprise, comprises, comprised and comprising” or any variation thereof and the terms include, includes, included and including” or any variation thereof are considered to be totally interchangeable and they should all be afforded the widest possible interpretation and vice versa.

The invention is not limited to the embodiments hereinbefore described but may be varied in both construction and detail.

1. A digital billboard control system, comprising:
at least one digital billboard having a real-time display and a traffic monitoring module adapted to detect and monitor traffic within a predetermined area adjacent the or each digital billboard in real-time; and
a data processing controller operably interfaced with the real-time display, the traffic monitoring module and a networking interface adapted to communicate bilaterally with a remote data processing terminal;
wherein the data processing controller is adapted to:
receive real-time traffic data from the traffic monitoring module;
determine at least one traffic pattern adjacent the or each digital billboard from the received data;
output media content data to the real-time display according to a comparison between the determined traffic pattern and at least one predetermined context criteria; and
communicate the determined traffic pattern and data representative of the media content data to the remote data processing terminal.

2. The digital billboard control system according to claim 1, wherein the at least one predetermined context criteria is selected from the group comprising traffic volume, traffic speed, traffic distribution, vehicle size, chronological data, meteorological data, geographical location of the or each billboard, display content type, display content duration, road safety information.

3. The digital billboard control system according to claim 1, wherein the data processing controller is interfaced with a plurality of real-time displays and traffic monitoring modules of respective digital billboards.

4. The digital billboard control system according to claim 1, comprising a plurality of data processing controllers, each interfaced with a real-time display and traffic monitoring module of a respective digital billboard.

5. The digital billboard control system according to claim 4, wherein the data processing controllers are in data communication with one another through respective network interfaces and each controller is further adapted to communicate the determined traffic pattern to a next data processing controller along a direction of traffic flow, such that a further predetermined context criteria comprises the communicated traffic pattern.

6. The digital billboard control system according to claim 1, wherein the data processing controller is further adapted to store the media content data as a plurality of video files and to select which video file to output according to the comparison.

7. The digital billboard control system according to claim 1, wherein the data processing controller is further adapted to select media content data stored remotely at a or the remote terminal according to the comparison, and to stream the selected media content data from the remote terminal for output to the real-time display.

8. The digital billboard control system according to claim 1, wherein the data processing controller downloads the or each predetermined context criteria from the remote data processing terminal.

9. The digital billboard control system according to claim 1, wherein the remote data processing terminal is adapted to process and output the determined traffic pattern and data representative of the media content data communicated by the data processing controller to a user interface.

10. A digital billboard, comprising:
a real-time display;
a traffic monitoring module adapted to detect and monitor traffic within a predetermined area adjacent the digital billboard in real-time;
a network interface adapted to communicate bilaterally with a remote data processing terminal; and
a data processing controller operably interfaced with the real-time display, the traffic monitoring module and the networking interface, and adapted to
receive real-time traffic data from the traffic monitoring module;
determine at least one traffic pattern adjacent the digital billboard from the received data;
output media content data to the real-time display according to a comparison between the determined traffic pattern and at least one predetermined context criteria; and
communicate the determined traffic pattern and data representative of the media content data to the remote data processing terminal.

11. The digital billboard according to claim 10, wherein the traffic monitoring module comprises a radar module adapted to detect each vehicle passing through the predetermined area.

12. The digital billboard according to claim 10, wherein the data processing controller is configurable and updateable by the remote terminal.

13. The digital billboard according to claim 10, wherein the data processing controller is in data communication with respective data processing controllers of adjacent digital billboards and wherein the controller is further adapted to communicate the determined traffic pattern to a next data processing controller along a direction of traffic flow, such that a further predetermined context criteria comprises the communicated traffic pattern.

14. The digital billboard according to claim 10, wherein the at least one predetermined context criteria is selected from the group comprising traffic volume, traffic speed, traffic distribution, vehicle size, chronological data, meteorological data, geographical location of the or each billboard, display content type, display content duration, road safety information.

15. A method of controlling a digital billboard adjacent a roadway, comprising the steps of:
detecting and monitoring traffic in real-time within a predetermined area adjacent the billboard with a traffic monitoring module;
communicating the real-time traffic data to a data processing controller and determining at least one traffic pattern adjacent the digital billboard from the received data;
comparing the determined traffic pattern with at least one predetermined context criteria and outputting media content data to a real-time billboard display according to the comparison; and
communicating the determined traffic pattern and data representative of the media content data to a remote data processing terminal with a network interface.

16. The method according to claim 15, wherein the at least one predetermined context criteria is selected from the group comprising traffic volume, traffic speed, traffic distribution, vehicle size, chronological data, meteorological data, geographical location of the or each billboard, media content data type, media content data duration, road safety information.

17. The method according to claim 16, wherein respective data processing controllers of a plurality of billboards are in data communication with one another through respective network interfaces, and wherein the method comprises the further step of communicating the determined traffic pattern to a next data processing controller along a direction of traffic flow, such that a further predetermined context criteria comprises the communicated traffic pattern.

18. The method according to claim 15, comprising the further steps of storing the media content data as a plurality of video files and wherein the step of outputting further comprises selecting which video file to output according to the comparison.

19. The method according to claim 15, wherein the step of outputting further comprises selecting media content data stored at a or the remote terminal according to the comparison, and streaming the selected remote media content data to the real-time display.

20. The method according to claim 15, further comprising a computer program comprising program instructions for causing a digital billboard controller operably interfaced with a traffic monitoring module to perform said detecting, said communicating the real-time traffic data, said comparing and said communicating the determined traffic pattern.
